(19) United States
(12) Patent Application Publication
(10) Pub. No.: US 2020/0318720 A1
(43) Pub. Date: Oct. 8, 2020

(54) ACTUATOR FOR LINK MECHANISM FOR INTERNAL COMBUSTION ENGINE AND WAVE GEAR SPEED REDUCER

(71) Applicant: HITACHI AUTOMOTIVE SYSTEMS, LTD.

(72) Inventors: Ken Bryan IKEGUCHI, Ayase-shi, Kanagawa (JP); Kotofumi YANAI, Utsunomiya-shi, Tochigi (JP)

(73) Assignee: HITACHI AUTOMOTIVE SYSTEMS, LTD., Hitachinaka-shi, Ibaraki (JP)

(21) Appl. No.: 16/084,193

(22) PCT Filed: Feb. 28, 2017
(86) PCT No.: PCT/JP2017/007667

§ 371 Date: Sep. 11, 2018

(30) Foreign Application Priority Data
Mar. 18, 2016 (JP) 2016-054589

(51) Int. Cl. F16H 49/00; F16H 1/32

(52) U.S. Cl. CPC F16H 49/001; F16H 55/0833; F16H 1/32

(57) ABSTRACT

Provided are an actuator for a link mechanism for an internal combustion engine and a wave gear speed reducer, which improve both input efficiency and driving efficiency. According to the invention, the wave gear speed reducer is configured so that a flexible external gear is bent into an elliptical shape using a wave generating device rotated by an input shaft to partially engage external teeth of the flexible external gear with internal teeth of an internal gear portion, and further configured so that an engaging part between the flexible external gear and the internal gear portion is rotated. The external teeth are larger in curvature than the internal teeth in a contact portion between the internal and external teeth.

### TECHNICAL FIELD

The invention relates to an actuator for a link mechanism for an internal combustion engine and a wave gear speed reducer.

### BACKGROUND ART

A well-known actuator for a link mechanism for an internal combustion engine is, for example, the actuator disclosed in a Patent Literature 1. This actuator for a link mechanism for an internal combustion engine includes a control shaft of a variable compression ratio mechanism and an actuator which changes a rotational position of the control shaft. The actuator is equipped with a wave gear speed reducer which reduces and transmits the rotation speed (revolution speed) of an electric motor to the control shaft. The technology disclosed in a Patent Literature 2 is related to a well-known wave gear speed reducer. This wave gear speed reducer, invented by C. W. Musser, is so configured that a planetary gear which is one of KHV planetary gears is bent into an elliptical shape and comes into engagement at a major axis end, and that a major axis rotation is one system of the apparatus.

The wave gear speed reducer comprises a thin-walled cylinder-like flexible external gear and a rigid internal gear whose number of teeth is an even multiple of the number of teeth of the flexible external gear. The flexible external gear and the rigid internal gear are coaxially arranged. The wave gear speed reducer is bent into an elliptical shape by a wave generating device fitted in an inside of the flexible external gear. Although the ellipse's major axis rotates in synchronization with a rotating motion inputted into the wave generating device, the flexible external gear remains deformed while being provided with degrees of rotational freedom in the circumferential direction and therefore makes a deforming motion while changing the position of engagement with the rigid internal gear on the ellipse's major axis. During the deforming motion, due to the tooth number difference between the flexible external gear and the rigid internal gear, a circumferential relative position between the rigid internal gear and the flexible external gear changes by the difference. The difference is outputted as speed reduction rotation.

### CITATION LIST

### Patent Literature

PTL 1: Japanese Unexamined Patent Application Publication (Kokai) No. 2012-251446

PTL 2: U.S. Pat. No. 2,906,143

### SUMMARY OF INVENTION

### Technical Problem

In the wave gear speed reducer, gear teeth keep changing the engagement position by making a relative motion in a radial direction of the gears while being in contact with one another. It is therefore important to consider the tooth profile of the flexible external gear and that of the rigid internal gear with a view to the relative motion of the teeth. The wave gear speed reducer disclosed in the Patent Literature 2 is capable of constantly maintaining teeth engagement at the major axis end and transmitting the rotation at the same time. In view of this, tooth profiles have been considered in pursuit of high positioning accuracy while increasing engagement area to improve high load torque performance. To that end, tooth contact area has been increased to enlarge the engagement area by designing tooth profiles so that the flexible external gear and the rigid internal gear are equal in tooth sectional curvature at their contact point, regardless of changes in position of a tooth contact point due to the relative motion, or by another way. On the other hand, in spite of the fact that the increase of the tooth contact area makes input efficiency relatively low when the gears rotate under a loaded condition, there has been no consideration of tooth profiles designed for driving efficiency.

One embodiment of the invention has been made in view of the foregoing issue. It is an object of the invention to provide an actuator for a link mechanism for an internal combustion engine and a wave gear speed reducer, which improve both input efficiency and driving efficiency.

### Solution to Problem

To achieve the object, the one embodiment of the invention includes a wave gear speed reducer in which external teeth of the flexible external gear are partially engaged with internal teeth of an internal gear portion while the flexible external gear is bent into an elliptical shape by a wave generating device which is rotated by an input shaft, and an engaging part between the flexible external gear and the internal gear portion is rotated. According to the wave gear speed reducer, the external teeth are larger in curvature than the internal teeth in a contact portion between the internal and external teeth.

The one embodiment of the invention thus can reduce contact area of the internal and external teeth and improve input efficiency, driving efficiency, and torque resistivity of the wave gear speed reducer.

### BRIEF DESCRIPTION OF DRAWINGS

FIG. 1 is a schematic view of an internal combustion engine equipped with an actuator for a link mechanism for an internal combustion engine according to an Embodiment 1.

FIG. 2 is a sectional view of the actuator for a link mechanism for an internal combustion engine according to the Embodiment 1.

FIG. 3 is an exploded isometric view of a wave gear speed reducer according to the Embodiment 1.

FIG. 4 is a schematic view showing an engagement state of a flexible external gear and a rigid internal gear according to the Embodiment 1.

FIG. 5 shows a relationship between addendum and dedendum according to the Embodiment 1.

FIG. 6 shows displacement of an engagement position between the rigid internal gear and the flexible external gear according to the Embodiment 1.

FIG. 7 is a correlation chart between contact area between the rigid internal gear and the flexible external gear and a curvature ratio of the rigid internal gear's tooth surface and the flexible external gear's tooth surface.

FIG. 8 shows each standard pitch circle of a cross-sectional surface perpendicular to an axis at a representative face width position of engagement of the wave gear speed reducer according to the Embodiment 1.

### DESCRIPTION OF EMBODIMENTS

### Embodiment 1

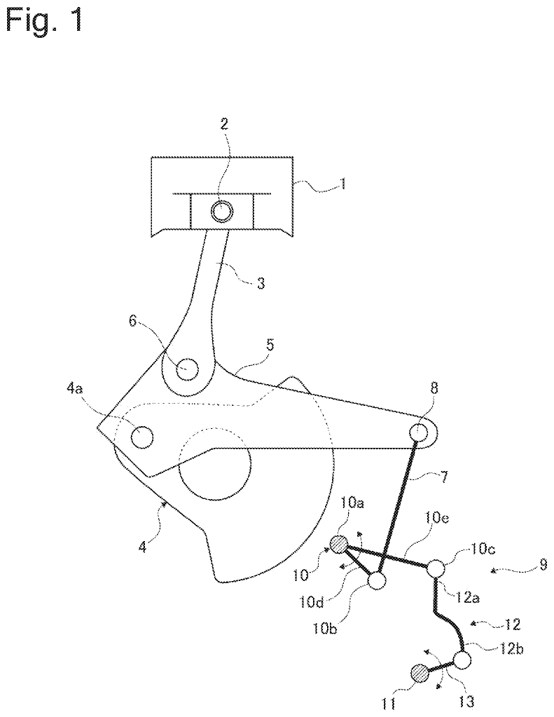

FIG. 1 is a schematic view of an internal combustion engine equipped with an actuator for a link mechanism for an internal combustion engine according to an Embodiment 1. The internal combustion engine has a basic structure similar to the one illustrated in FIG. 1 of the Japanese Unexamined Patent Application Publication (Kokai) No. 2011-169152, and therefore will be explained below in brief. The internal combustion engine includes a piston 1 which reciprocates within a cylinder of a cylinder block. An upper link 3 has an upper end rotatably coupled to the piston 1 through a piston pin 2. A lower link 5 is rotatably coupled to a lower end of the upper link 3 through a coupling pin 6. A crankshaft 4 is rotatably coupled to the lower link 5 through a crankpin 4a. A first control link 7 has an upper end portion rotatably coupled to the lower link 5 through a coupling pin 8. The first control link 7 further has a lower end portion coupled to a coupling mechanism 9 including a plurality of link members. The coupling mechanism 9 includes a first control shaft 10, a second control shaft 11, and a second control link 12 for coupling the first and second control shafts 10 and 11.

The first control shaft 10 extends in parallel with the crankshaft 4 extending in a direction of a cylinder row located inside the internal combustion engine. The first control shaft 10 includes a first journal portion 10a rotatably supported by an internal combustion engine body, a control eccentric shat portion 10b to which the lower end portion of the first control link 7 is rotatably coupled, and an eccentric shaft portion 10c to which one side portion 12a of the second control link 12 is rotatably coupled. A first arm portion 10d has one end coupled to the first journal portion 10a and the other end coupled to the lower end portion of the first control link 7. The control eccentric shaft portion 10b is disposed in a position which is eccentric to the first journal portion 10a by predetermined amount. A second arm portion 10e has one end coupled to the first journal portion 10a and the other end coupled to the one side portion 12a of the second control link 12. The eccentric shaft portion 10c is disposed in a position eccentric to the first journal portion 10a by predetermined amount. The second control link 12 has the other side portion 12b to which one end of an arm link 13 is rotatably coupled. The second control shaft 11 is coupled to the other end of the arm link 13. The arm link 13 and the second control shaft 11 do not make relative displacement. The second control 11 is rotatably supported within a later-described housing 20 through a plurality of journal portions.

The second control link 12 has a lever-like shape. The one side portion 12a coupled to the eccentric shaft portion 10c is formed in a substantially rectilinear manner, whereas the other side portion 12b to which the arm link 13 is coupled is formed in a curved manner. The one side portion 12a includes an end portion in which an insertion hole is formed to extend through the end portion. The eccentric shaft portion 10c turnably extends through the insertion hole. The arm link 13 is formed as a separate body from the second control shaft 11. A rotational position of the second control shaft 11 is shifted by torque transmitted from a drive motor 22 through a wave gear speed reducer 21 which is a part of the actuator for a link mechanism for an internal combustion engine. After the rotational position of the second control shaft 11 is shifted, the first control shaft 10 rotates through the second control link 12 to shift a position of the lower end portion of the first control link 7. The lower link 5 is thus changed in its position, which changes stroke position and amount of the piston 1 within the cylinder. An engine's compression ratio is then accordingly shifted.

(Configuration of the Actuator for a Link Mechanism for an Internal Combustion Engine)

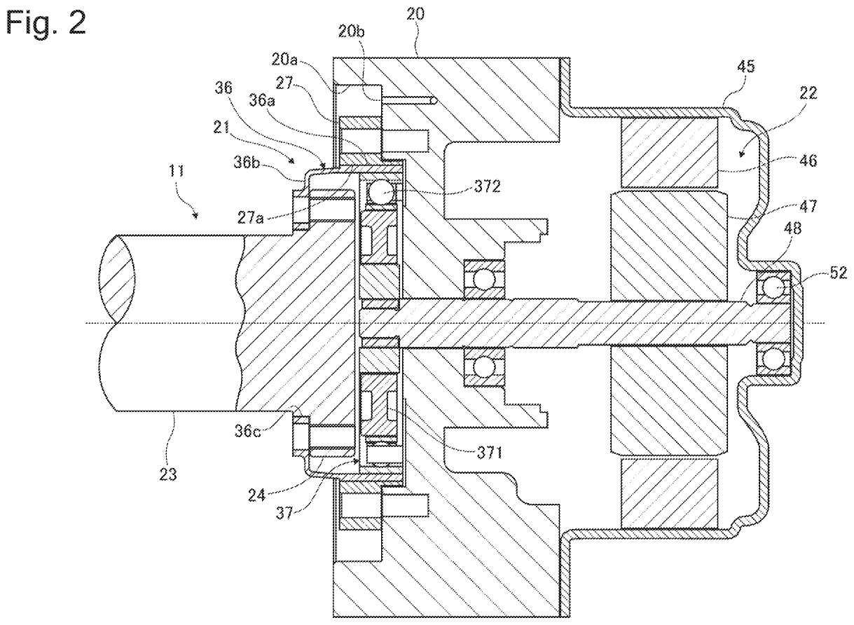

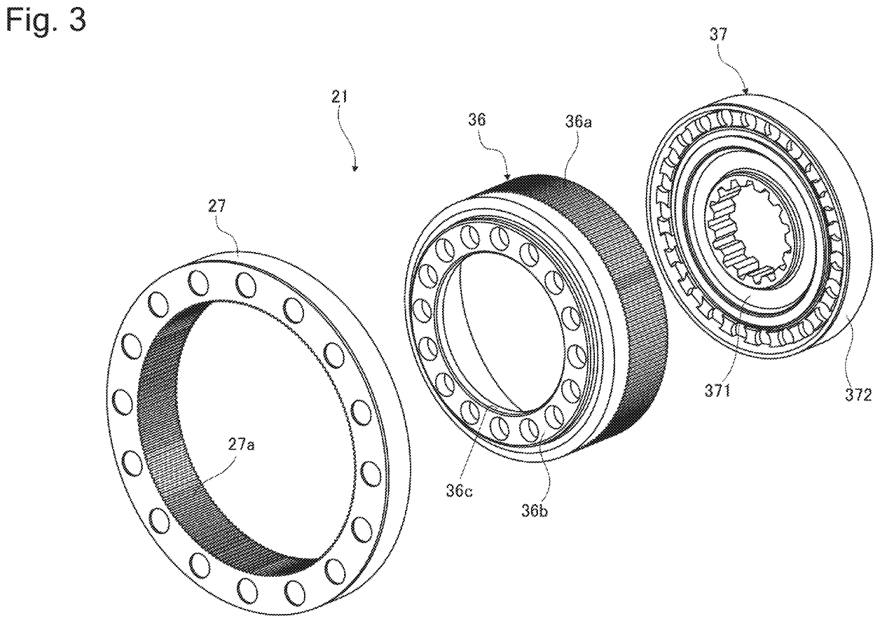

FIG. 2 is a sectional view of the actuator for a link mechanism for an internal combustion engine according to the Embodiment 1. FIG. 3 is an exploded isometric view of a wave gear device 3 according to the Embodiment 1. The actuator for a link mechanism for an internal combustion engine includes the drive motor 22, the wave gear speed reducer 21 fixed to a distal end side of the drive motor 22, the housing 20 in which the wave gear speed reducer 21 is accommodated, and the second control shaft 11 rotatably supported by the housing 20.

The drive motor 22 is a brushless motor. The drive motor 22 includes a bottomed cylinder-like motor casing 45, a tubular coil 46 fixed to an inner peripheral surface of the motor casing 45, a rotor 47 rotatably disposed in an inside of the coil 46, and a motor drive shaft 48 with one end portion 48a fixed at a center of the rotor 47. The motor drive shaft 48 is rotatably supported by a ball bearing 52 disposed in a bottom portion of the motor casing 45.

The second control shaft 11 includes a shaft portion body 23 extending in an axial direction, and a fixing flange 24 having a larger diameter than the shaft portion body 23. The second control shaft 11 comprises the shaft portion body 23 and the fixing flange 24 integrally made of a ferrous metal material. The fixing flange 24 is provided with a plurality of bolt insertion holes at an outer peripheral portion. The plurality of bolt insertion holes are arranged at regular intervals in a circumferential direction of the fixing flange 24. The fixing flange 24 is coupled to a flange portion 36b of a flexible external gear 36 of the wave gear speed reducer 21 with bolts inserted in the bolt insertion holes.

(Configuration of the Wave Gear Speed Reducer)

The wave gear speed reducer 21 is accommodated in an opening groove portion 20a of the housing 20. A feeding hole 20b opens in the opening groove portion 20a to be located gravitationally above the wave gear speed reducer 21. The feeding hole 20b supplies lubricant oil from a hydraulic power source, not shown, or the like. When the lubricant oil is supplied from the feeding hole 20b, the lubricant oil is dripped to the wave gear speed reducer 21 located beneath the feeding hole 20b, to thereby lubricate rotational elements. The wave gear speed reducer 21 includes an annular rigid internal gear 27 bolted within the opening groove portion 20a of the housing 20 and provided with a plurality of internal teeth 27a in an inner periphery, the flexible external gear 36 disposed on the inner periphery side of the rigid inner gear 27, deformable in a bent manner, and including an outer peripheral surface provided with external teeth 36a engaged with the internal teeth 27a, and a wave generating device 37 formed into an elliptical shape and having an outer peripheral surface which slides along an inner peripheral surface of the flexible external gear 36.

The flexible external gear 36 is made of a metal material. The flexible external gear 36 is a thin-walled cylinder-like member including a bottom portion and being deformable in the bent manner. The external teeth 36a of the flexible external gear 36 are fewer in number by two than the internal teeth 27a of the rigid internal gear 27. The flange portion 36b formed in the bottom portion of the flexible external gear 36 has an inner periphery formed with an insertion hole 36c through which the second control shaft 11 extends. The second control shaft 11 is inserted into the insertion hole 36c from the thin-walled cylinder-like member side of the flexible external gear 36, and the fixing flange 24 of the second control shaft 11 and the flange portion 36b are bolted together, which enables an inner periphery of the insertion hole 36c to be supported by the second control shaft 1, and also ensures rigidity of the bottom portion of the flexible external gear 36.

The wave generating device 37 includes a wave generator plug 371 having an elliptical shape, and a deep groove ball bearing 372 including flexible thin-walled inner and outer races which allow relative rotation between an outer periphery of the wave generator plug 371 and the inner periphery of the flexible external gear 36. The motor drive shaft 48 is press-fitted in a center of the wave generator plug 371 to be coupled to the wave generator plug 371.

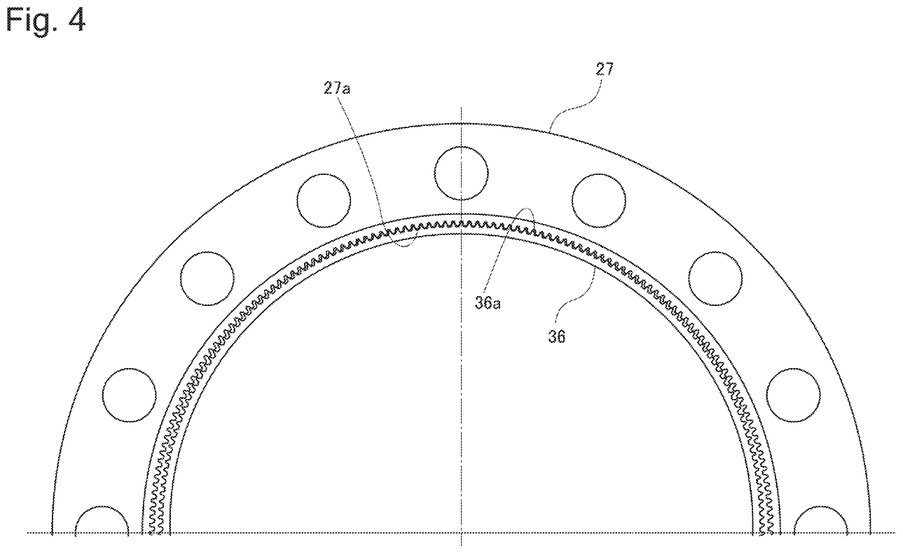

FIG. 4 is a schematic view showing an engagement state between the flexible external gear and the rigid internal gear according to the Embodiment 1. The wave generator plug 371 having an elliptical outer shape is fitted in the inner race of the deep groove ball bearing 372, and the deep groove ball bearing 372 follows the elliptical shape, so that the wave generating device 37 also has an elliptical outer shape. The flexible external gear 36 which is circular in an initial state is also deformed into an elliptical shape by fitting the wave generating device 37 in a bore of the flexible external gear 36. Since the flexible external gear 36 which has been bent into an ellipse has two teeth fewer than the rigid internal gear 27, the flexible external gear 36 and the rigid internal gear 27 are engaged together on an ellipse's major axis due to tooth pitch difference. On an ellipse's minor axis, the flexible external gear 36 and the rigid internal gear 27 are equal in tooth pitch. However, since the flexible external gear 36 is bent in the axial direction, the teeth of the flexible external gear 36 and those of the rigid internal gear 27 do not overlap and thus do not interfere with each other. The flexible external gear 36 and the rigid internal gear 27, which differ in number of teeth by an even multiple, can be therefore engaged with each other as shown by the engagement state in FIG. 4.

While a tooth portion of the flexible external gear 36 has flexibility, the flange portion 36b cannot be deformed from its circular shape for the purpose of retrieving output and is fastened directly to the second control shaft 11. The flexible external gear 36 therefore has a shape spreading out from the flange portion 36b toward a thin-walled cylinder-like opening end portion into an elliptical shape. This shape makes it possible to transmit a rotating motion of the flexible external gear 36, which is retrieved from a deforming motion in the vicinity of the opening end portion, from the flange portion 36b to the second control shaft 11.

Input of the rotation into the wave gear device is converted by the wave generating device 37 into a reciprocating displacement motion in a direction perpendicular to a rotation input shaft. The wave generator plug 371 including a rotation transmission mechanism is driven by an input shaft connected to the wave generator plug 371, and the inner race of the deep groove ball bearing 372 that is a fitting counterpart of the wave generator plug 371 is also accordingly driven. A shape of the inner race of the deep groove ball bearing 372 is transmitted to the outer race of the deep groove ball bearing 372 by balls held between the inner and outer races. The balls have six translational and rotational degrees of freedom, so that the inner and outer races have respective degrees of freedom in the circumferential direction. Since the wave generator plug 371 driven by the rotation input is an elliptic body, the wave generator plug 371 has a radius which varies depending on positions on a circumference of the ellipse. Due to such an elliptical characteristic, radius increase and decrease due to the rotation of the wave generator plug 371 are transmitted to the outer race of the wave generator plug 371 through the balls. Since the inner and outer races have a flexible thin-walled structure, the outer race of the deep groove ball bearing 372 makes a deforming motion synchronized with the radius increase and decrease in a case where the outer race is regulated in its degrees of freedom in the circumferential direction.

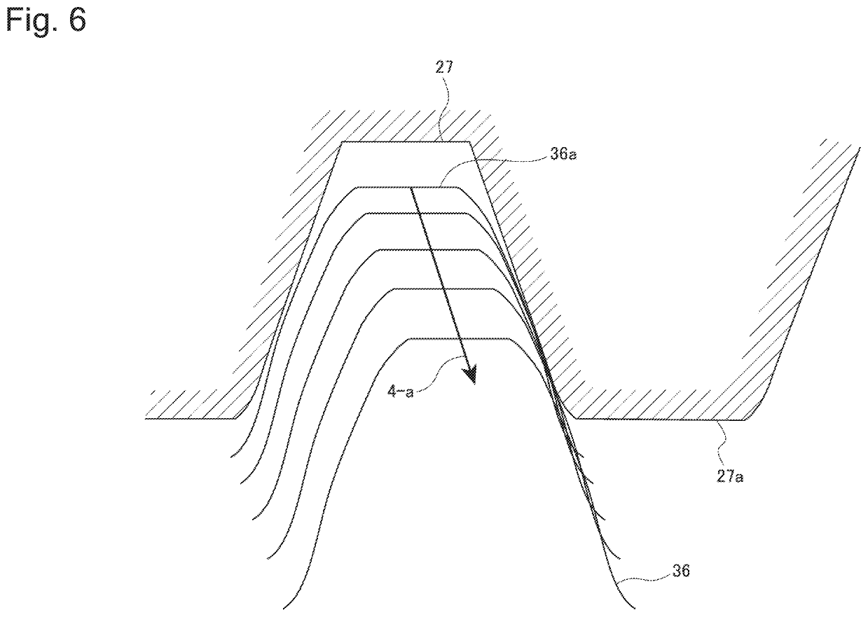

Since the outer race of the deep groove ball bearing 372 is fitted to the flexible external gear 36, the flexible external gear 36 also makes a deforming motion along with the deforming motion of the outer race. The deforming motion changes an engagement position on the major axis between the rigid internal gear 27 and the flexible external gear 36. FIG. 6 shows displacement of the engagement position between the rigid internal gear and the flexible external gear according to the Embodiment 1. If the tooth portion is observed on an enlarged scale from a fixed point on the rigid internal gear 27, what can be seen is a relative motion of the teeth in a direction perpendicular to the axis as illustrated in FIG. 6. The flexible external gear 36 changes its circumferential position relative to the rigid internal gear 27 due to difference, and thus keeps moving in the circumferential direction. As the result, each of the teeth of the flexible external gear 36 moves in a direction shown by an arrow (4-a) in FIG. 6. More specifically, each of the teeth of the flexible external gear 36 moves toward the bore side along a tooth surface of the corresponding internal tooth 27a.

Since the flexible external gear 36 is fastened to the second control shaft 11, when the second control shaft 11 receives torque from an external system, the torque is transmitted through the flange portion 36b to the flexible external gear 36 to cause the teeth of the flexible external gear 36 to push the respective teeth of the rigid internal gear 27. In this manner, the torque is received by the rigid internal gear 27. Hereinafter, a curvature of the internal teeth 27a is γs, and a curvature of the external teeth 36a is γe. On this condition, when a tooth sectional curvature of the flexible external gear 36 and that of the rigid internal gear 27 at a tooth contact point are γs≈γe as in a tooth profile of conventional wave gear devices, a contact surface is expanded according to an elastic contact theory to increase a tooth surface sliding resistance. This degrades input efficiency when load is applied to the wave gear speed reducer 21.

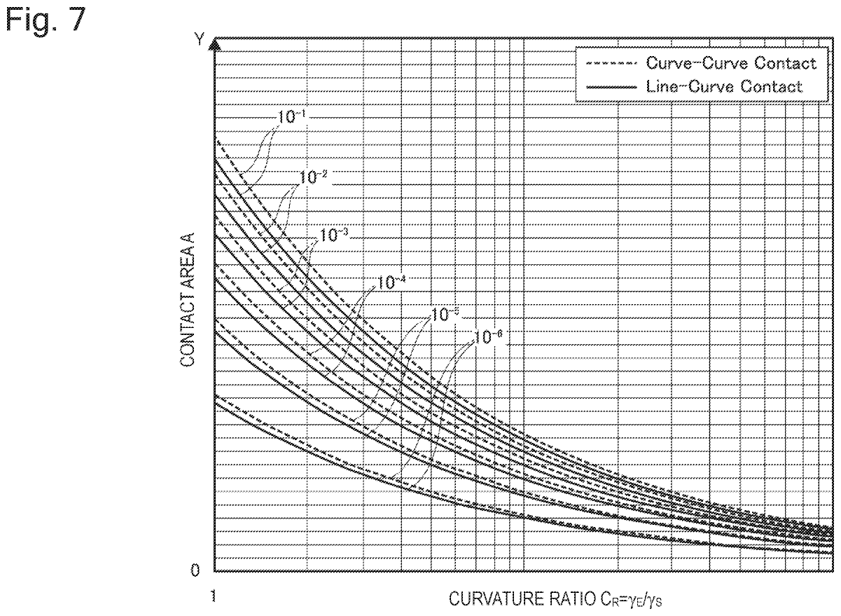

To solve the foregoing problem, the tooth sectional curvature of the flexible external gear 36 and that of the rigid internal gear 27 at the tooth contact point are determined as γs<<γe, and at the same time, the tooth profile is so designed that the engagement position can be shifted by the deforming motion of the flexible external gear 36. By so doing, contact area at the tooth contact point is reduced, decreasing the tooth surface sliding resistance and thus improving the input efficiency. FIG. 7 is a correlation chart between the contact area and the curvature ratio of the rigid internal gear tooth surface and the flexible external gear tooth surface. FIG. 7 is a logarithmic chart in which a characteristic shown by dotted lines is that of contact between curved lines, and a characteristic shown by solid lines is that of contact between a linear line and a curved line. In comparison between tooth profile contact area of curved lines (Curve-Curve Contact) according to conventional art and tooth profile contact area (Line-Curve Contact) according to the Embodiment 1, when the curved lines shift vertically upward along a Y-axis upon receiving a similar amount of torque from the second control shaft 11, the tooth profile contact area of the Embodiment 1 is less than that of the conventional art. The Embodiment 1 therefore has a less drag which acts in a direction of a tangent to the tooth contact surface.

The wave gear speed reducer 21 of the Embodiment 1 is characterized in that the tooth profile is designed in the following manner. An engagement state between the rigid internal gear 27 and the flexible external gear 36, which have a straight tooth profile with stub teeth, is obtained on the basis of basic data including a standard pitch circle DS and a speed reduction ratio ID of the rigid internal gear 27, and a standard pressure angle α. Subsequently, a straight tooth surface of the flexible external gear 36 is corrected to a single arc with the curvature γe, which contacts a tooth root R and a tooth top R in order to avoid an engagement interference at each engagement position.

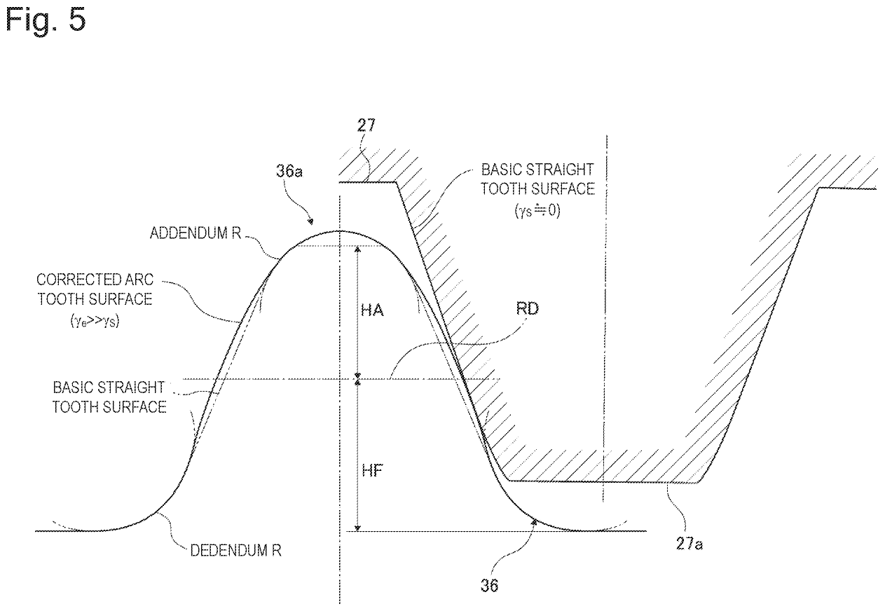

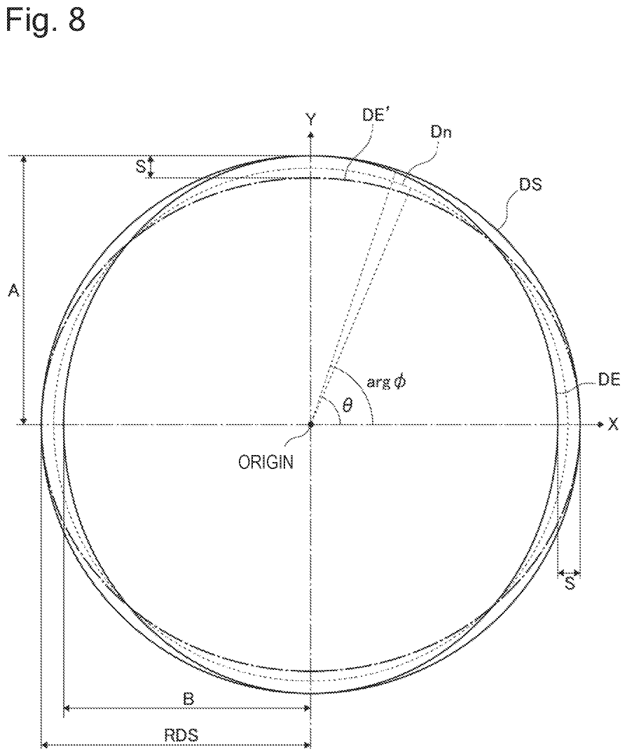

FIG. 8 shows each standard pitch circle of a cross-sectional surface perpendicular to an axis at an engagement representative face width position of the wave gear speed reducer according to the Embodiment 1. The standard pitch circles includes the standard pitch circle DS of the rigid internal gear 27 and a standard pitch circle DE of the flexible external gear 36. The standard pitch circle DE of the flexible external gear 36 is deformed by the wave generating device 37 and is constantly in an internal contact with the standard pitch circle DS of the rigid internal gear 27 at both ends on the major axis. For example, when the wave generator plug 371 makes a π/2 rotation, the standard pitch circle of the flexible external gear 36 is deformed as shown by DE′. A module M (value obtained by dividing a pitch circle diameter by the number of teeth) of the wave gear speed reducer 21 is obtained on the basis of a standard pitch circle radius RDS of the rigid internal gear 27 and the number of teeth Z determined by the preset speed reduction ratio ID. This determines addendum length HA and dedendum length HF measured from a standard pitch circle radius RDn of a neutral circle before the elliptical deformation of the wave gear speed reducer 21 of the Embodiment 1. FIG. 5 shows a relationship between the addendum and the dedendum. As shown in FIG. 5, the addendum HA and the dedendum HF of the tooth profile of the external tooth 36a having a straight distal end (hereinafter, referred to as a stub-tooth straight tooth mold) are expressed by the following Equations (1) and (2) using the module M.

HA=0.8×M [Equation (1)]

HF=1.0×M [Equation (2)]

From the addendum HA obtained by the Equation (1), a radial displacement amount of the wave gear speed reducer 21 can be obtained. This makes it possible to engage the flexible external gear 36 with the rigid internal gear 27 at a position where the flexible external gear 36 does not interfere with the rigid internal gear 27 on the minor axis, and where the standard pitch circles DS and DE contact each other on the major axis. This radial displacement amount is overall amplitude S shown in FIG. 8. A major axis radius A and a minor axis radius B are expressed by the following Equations (3) and (4). [Equation (3)] A=RDS [Equation (4)] B=RDS-S A proper “S” which satisfies HA<S is selected on the basis of requirements of the displacement amount. Once a standard pitch circle radius RD of the flexible external gear 36 in an elliptically deformed state is determined, the standard pitch circle radius RDn of the neutral circle before the elliptical deformation is (A+B)/2. It is thus possible to obtain the stub-tooth straight tooth profile of the flexible external gear 36 which has the same module as the rigid internal gear 27 and whose number of teeth is (Z−2).

Subsequently, the flexible external gear 36 in the neutral circle state is deformed into an elliptical shape with the teeth arranged thereon to obtain the engagement state with the rigid internal gear 27. Regular pitch points on the circumference are changed by the elliptical deformation. The following description is focused on deformation in a state where planes, namely horizontal and vertical planes, are represented by an X-axis and a Y-axis, respectively, when the axis is an origin on a cross-sectional surface perpendicular to the axis of the wave gear speed reducer 21 shown in FIG. 8. A relationship between an angle θ, which is formed by a line segment connecting the pitch point on the circumference in the neutral circle state and the origin to each other and the X-axis, and an angle ϕ (deflection angle), which is formed by the pitch point on an elliptical circumference after the elliptical deformation, is expressed by the following Equation (5). The Equation (5) is a model formula that describes the invention. A pitch deflection angle after deformation can be obtained by adjusting coefficients according to actual deformation. [Equation (5)]arg ϕ=arcsin[{(RDn−(S×cos³ θ))/P}×cos θ] “P” represents a radius difference between the ellipse and the neutral circle at the formed angle θ and is obtained as follows:

P=(A² sin² θ+B² cos² θ)^{1/2}−RDn

A sectional shape perpendicular to the axis of the flexible external gear and a sectional shape perpendicular to the axis of the rigid internal gear, which are obtained by the Equation (5), are superposed on each other to set tooth thickness and a tooth groove without interference. In this way, the wave gear speed reducer 21 using the stub-tooth straight tooth profile can be obtained. The invention is characterized in that the tooth surface sliding resistance is reduced by forming the tooth surface of the straight tooth profile into the single are having the curvature γe. As shown in FIG. 5, a procedure of obtaining a corrected tooth surface includes designing the tooth surface so that the tooth surface is inscribed in the tooth top R of the stub-tooth straight tooth and is circumscribed to the tooth bottom R of the stub-tooth straight tooth, and that the tooth surface does not interfere with the stub-tooth straight tooth of the rigid internal gear in the engagement state. In this manner, the wave gear device is provided with the tooth profiles in which the sliding resistance is reduced, and yet, the engagement is ensured.

### Advantageous Effects of the Embodiment 1

As discussed above, the Embodiment 1 provides advantageous effects listed below.

(1) The invention comprising:

the first and second control links 7 and 12 (control links) each having one side portion coupled to the link mechanism for an internal combustion engine;

the second control shaft 11 (control shaft) configured to rotate to change the position of the first and second control links 7 and 12;

the housing 20 configured to rotatably support the second control shaft 11; and

the wave gear speed reducer 21 configured to reduce and transmit the rotation speed (revolution speed) of the motor drive shaft 48 (output shaft) of the drive motor 22 to the second control shaft 11, wherein

the wave gear speed reducer 21 includes:

the rigid internal gear 27 (internal gear portion) disposed in the housing 20 and including internal teeth 27a;

the flexible external gear 36 located in an inside of the rigid internal gear 21, provided with the external teeth 36a at the outer periphery, and configured to transmit rotation to the second control shaft 11; and

the wave generating device 37 rotated by the motor drive shaft 48 of the drive motor 22, configured to bend the flexible external gear 36 into the elliptical shape to partially engage the external teeth 36a of the flexible external gear 36 with the internal teeth 27a of the rigid internal gear 27, and configured to rotate the engaging part between the flexible external gear 36 and the rigid internal gear 27; and

the external teeth 36a are larger in curvature than the internal teeth 27a in the contact portion between the internal and external teeth 27a and 36a.

It is therefore possible to reduce the contact area between the internal and external teeth 27a and 36a, and improve the driving efficiency and the torque resistivity of the actuator for a link mechanism for an internal combustion engine.

(2) The actuator for a link mechanism for an internal combustion engine according to the (1), wherein a basic profile of each of the external teeth 36a of the flexible external gear 36 is such a straight tooth profile that each of the external teeth 36a does not contact each of the internal teeth 27a in a state where the flexible external gear 36 is bent by the wave generating device 37 at a maximum in a radial direction, and the external teeth 36a with the straight tooth profile are subjected to overlay with respect to tooth thickness so that the external teeth 36a contact in the state where the flexible external gear 36 is bent by the wave generating device 37 at the maximum in the radial direction. The tooth thickness here particularly means tooth thickness along the standard pitch circle radius RD of the flexible external gear 36 in the elliptically deformed state.

It is therefore possible to ensure the rigidity of the external teeth 36a.

(3) The actuator for a link mechanism for an internal combustion engine according to the (1), wherein each of the internal teeth 27a is formed to have a straight tooth profile.

It is therefore possible to reduce contact resistance generated when the external tooth 36a moves inwardly in the radial direction along the internal tooth 27a.

(4) The actuator for a link mechanism for an internal combustion engine according to the (3), wherein each of the external teeth 36a is formed to have a curved tooth profile. It is therefore possible to reduce contact area between the internal and external teeth 27a and 36a.

(5) The actuator for a link mechanism for an internal combustion engine according to the (1), wherein the housing 20 includes the feeding hole 20b for supplying the lubricant oil to the wave gear speed reducer 21.

It is therefore possible to lubricate the wave gear speed reducer 21.

(6) The actuator for a link mechanism for an internal combustion engine according to the (5), wherein the feeding hole 20b is disposed gravitationally above a shaft center of the second control shaft 11. It is therefore possible to feed the lubricant oil supplied through the feeding hole 20b in a dripping manner without separately providing a mechanism or the like for supplying the lubricant oil.

(7) The actuator for a link mechanism for an internal combustion engine according to the (1), wherein the rigid internal gear 27 is an annular member fixed to the housing 20; and the flexible external gear 36 is formed into a bottomed cylinder-like shape and provided with the external teeth 36a at an outer periphery of a cylinder portion, the flexible external gear 36 including the flange portion 36b which is a bottom portion, to which the second control shaft 11 is fixed.

It is therefore possible to ensure the rigidity of the flexible external gear 36.

(8) The actuator for a link mechanism for an internal combustion engine according to the (7), wherein the flange portion 36b which is the bottom portion of the flexible external gear 36 includes the insertion hole 36c through which the second control shaft 11 extends. It is therefore possible to support the flange portion 36b which is the bottom portion by the second control shaft 11 and ensure the rigidity of the flexible external gear 36.

(9) The invention comprising:

the rigid internal gear 27 (internal gear portion) disposed in the housing 20 and including the internal teeth 27a;

the flexible external gear 36 located in the inside of the rigid internal gear 27, provided with the external teeth 36a at the outer periphery, and configured to transmit rotation to the second control shaft 11 (output shaft); and

the wave generating device 37 rotated by the motor drive shaft 48 (input shaft), configured to bend the flexible external gear 36 into an elliptical shape to partially engage the external teeth 36a of the flexible external gear 36 with the internal teeth 27a of the rigid internal gear 27, and configured to rotate the engaging part between the flexible external gear 36 and the rigid internal gear 27, wherein

the external teeth 36a are larger in curvature than the internal teeth 27a in the contact portion between the internal and external teeth 27a and 36a.

It is therefore possible to improve the driving efficiency and the torque resistivity of the wave gear speed reducer 21.

(10) The wave gear speed reducer 21 according to the (9), wherein a basic profile of each of the external teeth 36a of the flexible external gear 36 is such a straight tooth profile that each of the external teeth 36a does not contact each of the internal teeth 27a in a state where the flexible external gear 36 is bent by the wave generating device 37 at a maximum in a radial direction, and the external teeth 36a are subjected to overlay to obtain the straight tooth profile with overlaid tooth thickness so that each of the external teeth 36a contacts each of the internal teeth 27a in the state where the flexible external gear 36 is bent by the wave generating device 37 at the maximum in the radial direction.

It is therefore possible to ensure the rigidity of the external teeth 36a.

(11) The wave gear speed reducer 21 according to the (9), wherein each of the internal teeth 27a is formed to have a straight tooth profile.

It is therefore possible to reduce contact resistance generated when the external tooth 36a moves inwardly in the radial direction along the internal tooth 27a.

(12) The wave gear speed reducer 21 according to the (11), wherein each of the external teeth 36a is formed to have a curved tooth profile.

It is therefore possible to reduce contact area between the internal and external teeth 27a and 36a.

(13) The wave gear speed reducer 21 according to the (9), wherein a plane formed of the X- and Y-axes orthogonal to each other with the rotational axis served as the origin is defined on a cross-sectional surface perpendicular to the rotational axis of the flexible external gear 36, and when the angle formed by the line segment connecting the pitch point on the circumference of the flexible external gear 36 in the neutral circle state and the origin to each other and the X-axis is θ; the angle formed by the line segment connecting the pitch point on the elliptical circumference of the flexible external gear 36 deformed into an elliptical shape and the origin to each other and the X-axis is ϕ; the basic standard pitch circle radius RDn of the external teeth 36a and the internal teeth 27a; and the overall amplitude that is a radial motion amount which allows teeth engagement at the position where the flexible external gear 36 does not interfere with the rigid internal gear 27 on the minor axis, and where the standard pitch circle Dn contacts on the major axis, is S, a relationship described by arg ϕ=arcsin[{(RDn−(S×cos³ θ))/((A² sin² θ+B² cos² θ)^{1/2}−RDn)}×cos θ] is satisfied.

It is therefore possible to obtain the tooth profile of the wave gear device, in which the tooth surface sliding resistance is reduced, and yet, the engagement is ensured.

### Other Embodiments

The invention has been described on the basis of the embodiments. Instead of the foregoing embodiments, other configurations may be adopted. According to the Embodiment 1, for example, the invention is applied to the variable compression ratio mechanism capable of varying the compression ratio for an internal combustion engine. Instead, the invention may also be applied to a valve timing control system for an internal combustion engine, which is described in the Japanese Unexamined Patent Application Publication Nos. 2015-1190, 2011-231700, and other like documents, and a variable steering angle mechanism capable of varying a turning angle relative to a steering angle.

Although the embodiments of the invention have been described, one skilled in the art should easily understand that the exemplary embodiments may be modified or improved in various ways without materially departing from the novel teachings and advantages of the invention. Accordingly, all such modifications and improvement are intended to be included within the technical scope of the invention. The embodiments may be combined in any manner.

The present application claims priority under Japanese Patent Application No. 2016-054589 filed on Mar. 18, 2016. The entire disclosure of Japanese Patent Application No. 2016-054589 filed on Mar. 18, 2016, including the description, claims, drawings and abstract, is incorporated herein by reference in its entirety.

### REFERENCE SIGN LIST

1: Piston
7: First control link
10: First control shaft
11: Second control shaft
12: Second control link
20: Housing
20b: Feeding hole
21: Wave gear speed reducer
22: Drive motor
24: Fixing flange
27: Rigid internal gear
27a: Internal teeth
36: Flexible external gear
36a: External teeth
36b: Flange portion
36c: Insertion hole
37: Wave generating device
48: Motor drive shaft
371: Wave generator plug
372: Deep groove ball bearing

1. An actuator for a link mechanism for an internal combustion engine, comprising:
a control shaft configured to rotate the control shaft to change a position of a control link coupled to a link mechanism for an internal combustion engine;
a housing configured to rotatably support the control shaft; and
a wave gear speed reducer configured to reduce and transmit rotation speed of an output shaft of a drive motor to the control shaft, wherein
the wave gear speed reducer includes:
an internal gear portion disposed in the housing and including internal teeth;
a flexible external gear located in an inside of the internal gear portion, provided with external teeth at an outer periphery of the flexible external gear, and configured to transmit rotation to the control shaft; and
a wave generating device rotated by the output shaft of the drive motor, the wave generating device being configured to bend the flexible external gear into an elliptical shape to partially engage the external teeth of the flexible external gear with the internal teeth of the internal gear portion, and configured to rotate an engaging part between the flexible external gear and the internal gear portion, wherein
the external teeth are larger in curvature than the internal teeth in a contact portion between the internal and external teeth.

2. The actuator for a link mechanism for an internal combustion engine according to claim 1, wherein
a basic profile of each of the external teeth of the flexible external gear is a straight tooth profile in which a tooth surface on a reference pitch circle of each of the external teeth in a state where the flexible external gear is bent by the wave generating device at a maximum in a radial direction does not contact a tooth surface of each of the internal teeth;
the external teeth with the straight tooth profile is subjected to overlay with respect to tooth thickness along the reference pitch circle of the external teeth so that each of the external teeth can contact the tooth surface of each of the internal teeth in the state where the flexible external gear is bent by the wave generating device at the maximum in the radial direction.

3. The actuator for a link mechanism for an internal combustion engine according to claim 1, wherein
a contact portion of each of the internal teeth, which contacts a tooth surface of each of the external teeth, is formed into a straight tooth profile.

4. The actuator for a link mechanism for an internal combustion engine according to claim 3, wherein
a contact portion of each of the external teeth, which contacts a tooth surface of each of the internal teeth, is formed into a curved tooth profile.

5. The actuator for a link mechanism for an internal combustion engine according to claim 1, wherein
the housing includes a feeding hole for supplying lubricant oil to the wave gear speed reducer.

6. The actuator for a link mechanism for an internal combustion engine according to claim 5, wherein
the feeding hole is disposed gravitationally above a shaft center of the control shaft.

7. The actuator for a link mechanism for an internal combustion engine according to claim 1, wherein
the internal gear portion is an annular member fixed to the housing;
the flexible external gear is formed into a bottomed cylinder-like shape;
the external teeth are provided at an outer periphery of a cylinder portion of the flexible external gear; and
the control shaft is fixed to a bottom portion of the flexible external gear.

8. The actuator for a link mechanism for an internal combustion engine according to claim 7, wherein
the bottom portion of the flexible external gear includes an insertion hole through which the control shaft extends.

9. The actuator for a link mechanism for an internal combustion engine according to claim 1, wherein
a plane formed of X- and Y-axes orthogonal to each other with the rotational axis served as an origin is defined on a cross-sectional surface perpendicular to the rotational axis of the flexible external gear; and
when an angle formed by a line segment connecting a pitch point on a circumference of the flexible external gear in a neutral circle state and the origin to each other and the X-axis is θ;
an angle formed by a line segment connecting a pitch point on an elliptical circumference of the flexible external gear deformed into an elliptical shape and the origin to each other and the X-axis is ϕ; a fundamental standard pitch circle radius RDn of the external and internal teeth; and overall amplitude that is a radial motion amount which allows teeth engagement at a position where the flexible external gear does not interfere with the rigid internal gear on a minor axis and where the standard pitch circle contacts on a major axis is S, a relationship described by arg ϕ=arcsin[{(RDn−(S×cos³ θ))/((A² sin² θ+B² cos² θ)^{1/2}−RDn)}×cos θ] is satisfied.

10. A wave gear speed reducer comprising:
an internal gear portion disposed in a housing and including internal teeth;
a flexible external gear located in an inside of the internal gear portion, provided with external teeth at an outer periphery of the flexible external gear, and configured to transmit rotation to an output shaft; and
a wave generating device rotated by an input shaft, the wave generating device being configured to bend the flexible external gear into an elliptical shape to partially engage external teeth of the flexible external gear with internal teeth of the internal gear portion, and configured to rotate an engaging part between the flexible external gear and the internal gear portion, wherein
the external teeth are larger in curvature than the internal teeth in a contact portion between the internal and external teeth.

11. The wave gear speed reducer according to claim 10, wherein
a basic profile of each of the external teeth of the flexible external gear is such a straight tooth profile in which each of the external teeth does not contact each of the internal teeth in a state where the flexible external gear is bent by the wave generating device at a maximum in a radial direction; and
the external teeth with the straight tooth profile is subjected to overlay with respect to tooth thickness along the reference pitch circle of the external teeth so that each of the external teeth contacts each of the internal teeth in the state where the flexible external gear is bent by the wave generating device at the maximum in the radial direction.

12. The wave gear speed reducer according to claim 10, wherein
each of the internal teeth is formed to have a straight tooth profile.

13. The wave gear speed reducer according to claim 12, wherein each of the external teeth is formed to have a curved tooth profile.

14. The wave gear speed reducer according to claim 10, wherein
a plane formed of X- and Y-axes orthogonal to each other with the rotational axis served as an origin is defined on a cross-sectional surface perpendicular to the rotational axis of the flexible external gear; and
when an angle formed by a line segment connecting a pitch point on a circumference of the flexible external gear in a neutral circle state and the origin to each other and the X-axis is θ;
an angle formed by a line segment connecting a pitch point on an elliptical circumference of the flexible external gear deformed into an elliptical shape and the origin to each other and the X-axis is ϕ; a fundamental standard pitch circle radius RDn of the external and internal teeth; and overall amplitude that is a radial motion amount which allows teeth engagement at a position where the flexible external gear does not interfere with the rigid internal gear on a minor axis and where the standard pitch circle contacts on a major axis is S, a relationship described by arg ϕ=arcsin[{(RDn−(S×cos³ θ))/((A² sin² θ+B² cos² θ)^{1/2}−RDn)}×cos θ] is satisfied.
